(19) United States
(12) Patent Application Publication
(10) Pub. No.: US 2025/0319813 A1
(43) Pub. Date: Oct. 16, 2025

(54) VEHICLE ACCESSORY MOUNTING APPARATUS WITH ANGLE ADJUSTMENT

(71) Applicant: NOMADYN INC., Oak Bluff (CA)

(72) Inventor: Michael T. Cole, Oak Bluff (CA)

(21) Appl. No.: 19/172,875

(22) Filed: Apr. 8, 2025

Related U.S. Application Data
(60) Provisional application No. 63/633,932, filed on Apr. 15, 2024.

(51) Int. Cl. B60Q 1/26; B60Q 1/00

(52) U.S. Cl. CPC B60Q 1/2661; B60Q 1/0088

(57) ABSTRACT

An accessory mounting apparatus supports a lighting module and an auxiliary accessory on a vehicle that has existing fasteners securing an exterior body portion of the vehicle. The apparatus has a base body with fastener apertures that align with the existing fasteners on the vehicle for mounting thereon. A mounting body has a bridge fastened to the base body, two arms forming a U-shape with the bridge, and fastener apertures in the arms to mount the lighting module for angular adjustment about a common axis of the apertures in the arms. An auxiliary mount on the mounting body supports an auxiliary accessory thereon independently of the lighting module. Use of existing fasteners of the vehicle and various mounts on the mounting body allow various accessories together with an adjustable lighting module to be well secured on the exterior of the vehicle in a highly adaptable and interchangeable manner.

This application claims the benefit under 35 U.S.C.119(e) of U.S. provisional application Ser. No. 63/633,932, filed Apr. 15, 2024.

### FIELD OF THE INVENTION

The present invention relates to an apparatus for mounting accessories including a lighting module including one or more mounting bodies arranged to be supported externally on the vehicle to support the lighting module for angular adjustment relative to the vehicle, and more particularly the present invention relates to an accessory mounting apparatus arranged to receive a plurality of different accessories interchangeably with one another relative to a common base mountable on the exterior of the vehicle.

### BACKGROUND

When driving vehicles off-road or in remote areas it is desirable to support auxiliary lighting on the vehicle to assist in navigating the vehicle, in addition to a variety of other accessories related to operation of the vehicle on the exterior of the vehicle including secondary lighting, cameras, a compressed air supply, an auxiliary electrical power outlet, etc. This is typically accomplished by mounting individual components such as an individual lighting assembly externally on the vehicle; however, the accessory can become cluttered when mounted individually. Furthermore, the limited number of suitable mounting locations on the exterior of the vehicle limits the number of accessories that can be conveniently mounted on the exterior of the vehicle.

### SUMMARY OF THE INVENTION

According to one aspect of the invention there is provided an accessory mounting apparatus for supporting a lighting module and an auxiliary accessory on a vehicle having existing fasteners securing an exterior body portion of the vehicle, the apparatus comprising:
a base body having a pair of first fastener apertures formed therein for alignment with the existing fasteners on the vehicle so as to be arranged to mount the base body externally onto the vehicle using the existing fasteners and at least one second fastener aperture;
a mounting body having (i) a bridge locating at least one first fastener aperture so as to be arranged to fasten the bridge to said at least one second fastener aperture of the base body, and (ii) two arms extending outwardly from the bridge at spaced apart locations to form a U-shape with the bridge, wherein the two arms include second fastener apertures therein respective along a common axis at a location spaced from the bridge, and wherein the second fastener apertures of the two arms are arranged receive fasteners of the lighting module therein such that the lighting module is angularly adjustable about said common axis; and
at least one auxiliary mount formed on the mounting body and arranged to receive the auxiliary accessory supported on the mounting body independently of the lighting module.

The use of a base body arranged for mounting on existing fasteners of the vehicle allow the apparatus to be well secured on the exterior of the vehicle. The configuration of the mounting body fastened to the base body and providing separate mounts for the lighting module and an auxiliary accessory further allow the mounting body to support more than one accessory on the base body, while also being interchangeable with other mounting body configurations is desired. The overall configuration of the apparatus is thus highly adaptable to support a variety of different accessories externally on the vehicle in a secure manner.

Preferably said at least one second fastener aperture in the base body comprises two or more second fastener apertures, and said at least one first fastener aperture in the mounting body comprises two or more first fastener apertures which are internally threaded for forming a threaded connection with fasteners extending through the second fastener apertures in the base body.

Preferably the mounting body is securable in fixed relation to the base body in a first orientation and a second orientation which is angularly offset from the first orientation about an upright axis.

Preferably said at least one second fastener aperture in the base body comprises a plurality of second fasteners apertures, and said at least one first fastener aperture in the mounting body comprises a plurality of first fastener apertures, in which at least two of the second fastener apertures in the base body are aligned with at least two of the first fastener apertures in the mounting body in each of the first and second orientations.

The base body may comprise a first body portion at a first end of the base body locating the first fastener apertures therein and a second body portion at an opposing second end of the base body locating said at least one second fastener aperture therein. The base body may be a plate that forms the first body portion and the second body portion substantially in a common plane with one another, in which the first body portion is elongated along a first axis and the second body portion is elongated along a second axis oriented perpendicularly to the first axis.

The base body may comprise (i) a first flange defining a first body portion locating the first fastener apertures therein and (ii) a second flange defining a second body portion locating the at least one second fastener aperture therein, in which the first flange and the second flange are joined to one another at an acute angle.

Preferably said at least one auxiliary mount is formed on one of the arms between the bridge and the respective second fastener aperture of the arm.

In some embodiments, said at least one auxiliary mount comprises two auxiliary mounts located on the two arms respectively between the bridge and the respective second fastener apertures of the arms.

Said at least one auxiliary mount may comprise (i) a threaded bore arranged to receive a fastener securing the auxiliary accessory to the mounting body such that the auxiliary accessory is angularly adjustable about an auxiliary axis of the threaded bore, and (ii) an interlocking connector arranged to form an interlocking connection with the auxiliary accessory to fix the auxiliary accessory at a selected angular orientation about the auxiliary axis.

The interlocking connector may comprise a protrusion formed on a first one of the mounting body and the auxiliary accessory and at least one socket formed on a second one of the mounting body and the auxiliary accessory in which the socket receives the protrusion therein at the selected angular orientation.

Preferably the at least one socket comprises a plurality of sockets, in which each socket is arranged to receive the protrusion therein at a different selected angular orientation of the auxiliary accessory relative to the mounting body about the auxiliary axis.

The apparatus may further comprise an intermediate body including (i) a flange portion arranged to be received between the mounting body and the base body and having at least one intermediate aperture therein for alignment with said at least one second fastener aperture of the base body such that the mounting body and the intermediate body are securable to the base body using a common fastener received therethrough, and (ii) a working portion arranged to support a secondary vehicle accessory thereon. The working portion of the intermediate body may include a through passage arranged to receive a compressed air supply line communicating therethrough.

The auxiliary accessory may be a lighting mount arranged to supporting a secondary lighting module thereon, in which the lighting mount includes a bridge removably coupled to said at least one auxiliary mount and two arms extending outwardly from the bridge at spaced apart locations to form a U-shape with the bridge, and in which the two arms include secondary fastener apertures therein respectively along a secondary axis at a location spaced from the bridge. Preferably the secondary fastener apertures of the two arms are arranged to receive fasteners of the secondary lighting module therein such that the secondary lighting module is angularly adjustable about said secondary axis.

When the auxiliary accessory is a camera mount arranged to support a camera thereon, the camera mount is preferably removably coupled to said at least one auxiliary mount on the mounting body.

When the auxiliary accessory is an antenna mount arranged to support an antenna thereon, the antenna mount is preferably removably coupled to said at least one auxiliary mount on the mounting body.

The apparatus may further include an intermediate body including (i) a flange portion arranged to be received between said at least one auxiliary mount on the mounting body and the auxiliary accessory and having at least one intermediate aperture therein for alignment with said at least one auxiliary mount such that the auxiliary accessory and the intermediate body are securable to the mounting body using a common fastener received therethrough, and (ii) a working portion arranged to support a secondary vehicle accessory thereon. The working portion of the intermediate body may include a through passage arranged to receive a compressed air supply line communicating therethrough.

When the auxiliary accessory is an electrical socket mount arranged to support an electrical socket thereon, the electrical socket mount is preferably removably coupled to said at least one auxiliary mount on the mounting body.

### BRIEF DESCRIPTION OF THE DRAWINGS

Various embodiments of the invention will now be described in conjunction with the accompanying drawings in which:

FIG. 1 is a perspective view of the accessory mounting apparatus according to a first embodiment;

FIG. 2 is another perspective view of the accessory mounting apparatus according to the first embodiment of FIG. 1;

FIGS. 3 and 4 are exploded views of the accessory mounting apparatus according to the first embodiment of FIG. 1;

FIG. 5 is a perspective view of the accessory mounting apparatus according to a second embodiment;

FIGS. 6 and 7 are perspective views of the antenna mounts of the accessory mounting apparatus according to the second embodiment of FIG. 5;

FIG. 8 is a perspective view of the base body of the accessory mounting apparatus shown supported on a vehicle according to the embodiments of FIGS. 1 through 18;

FIG. 9 is a perspective view of a mounting body of the accessory mounting apparatus according to a further embodiment;

FIG. 10 is a perspective view of various additional embodiments of the mounting body of the accessory mounting apparatus which can be interchangeably mounted on the base body;

FIG. 11 is a perspective view of the accessory mounting apparatus according to a further embodiment in which the auxiliary accessory is a camera mount;

FIG. 12 is a perspective view of the camera mount of the accessory mounting apparatus according to the embodiment of FIG. 11;

FIG. 13 is a perspective view of the accessory mounting apparatus according to a further embodiment in which the auxiliary accessory is an alternate camera mount;

FIG. 14 is a perspective view of the camera mount of the accessory mounting apparatus according to the embodiment of FIG. 13;

FIG. 15 is an exploded view of the camera mount of the accessory mounting apparatus according to the embodiment of FIG. 13;

FIG. 16 is a sectional view of the camera mount of the accessory mounting apparatus according to the embodiment of FIG. 13;

FIG. 17 is a perspective view of the accessory mounting apparatus according to a further embodiment in which the auxiliary accessory is a power socket adapter mount;

FIG. 18 is an exploded view of the power socket adapter mount of the accessory mounting apparatus according to the embodiment of FIG. 17;

FIG. 19 is a perspective view of the accessory mounting apparatus according to a further embodiment of the base body;

FIG. 20 is a perspective view of the base body of the accessory mounting apparatus according to the embodiment of FIG. 19, shown supported on the vehicle;

FIG. 21 is an exploded view of the accessory mounting apparatus according to the embodiment of FIG. 19;

FIG. 22 is a side view of the accessory mounting apparatus according to the embodiment of FIG. 19; and

FIGS. 23 and 24 are perspective views of a further embodiment of the base body of the accessory mounting apparatus, for mounting on the vehicle according to FIG. 20.

In the drawings like characters of reference indicate corresponding parts in the different figures.

### DETAILED DESCRIPTION

Referring to the accompanying figures there is illustrated an accessory mounting apparatus generally illustrated by reference numeral 10. The accessory mounting apparatus 10 is intended for mounting vehicular accessories in an externally accessible manner on the exterior body of a vehicle 12 as described in the following.

Although adapted to mount a variety of different accessories on the vehicle, the apparatus 10 primarily serves to mount a primary lighting module 14 externally on the vehicle in which the primary lighting module includes threaded mounting sockets at laterally opposing sides of a housing of the module to receive threaded fasteners therein along a common axis spanning laterally across the housing.

The apparatus 10 is generally intended for mounting on the exterior of a vehicle using existing threaded fasteners that are externally accessible on the vehicle according to the illustrated embodiment. In the illustrated embodiment, the vehicle 12 includes an engine compartment positioned forwardly of a front windshield 16 of the vehicle in which the engine compartment is enclosed from above primarily by a hood panel 18 of the vehicle. The hood panel 18 is hinged relative to the vehicle by respective hinges secured by hinge fasteners 19. A cowl panel 20 spans laterally across the vehicle between the hood panel 18 and the windshield 16. Cowl fasteners 22 are situated in pairs at laterally opposing ends of the cowl panel 20 for securement of exterior finishing panels of the vehicle. The vehicle body further includes A-pillars 26 extending upright along opposing sides of the front windshield 16. An A-pillar bracket 28 is situated at the base of each A-pillar 26 and is secured relative to the frame of the vehicle by bracket fasteners 30 at a location forwardly of the front doors 32 of the vehicle and above the front fender panels 34 of the vehicle. According to the various embodiments of the apparatus 10 described in the following, the apparatus can be secured to the vehicle by removing and replacing the externally accessible cowl fasteners 22 or the A-pillar bracket fasteners 28.

In further embodiments, the apparatus may be secured externally on the vehicle by fastening through the apparatus 10 using replacement hood hinge fasteners 19.

The apparatus 10 according to the various embodiments described herein generally includes a base body 40 having a first body portion 42 locating first fastener apertures 44 therein for fastening to the existing fasteners of the vehicle and a second body portion 46 locating second fastener apertures 48 therein in the form of internally threaded bores to interchangeably fasten additional components of the apparatus 10 thereon.

The apparatus 10 further includes a mounting body 50 including a bridge portion 52 having first fastener apertures 54 therein for cooperating with the fastener apertures in the second body portion 46 of the base body and two arms 56 which extend upwardly from opposing ends of the bridge portion 52 in a generally U-shaped configuration for locating second fastener apertures 58 therein adjacent the distal ends of the arms 56 respectively for cooperating with the mounting sockets at opposing sides of the primary lighting module 14. The second fastener apertures 58 in the arms 56 are accordingly aligned with one another along a common axis that is parallel to and spaced from the bridge portion to receive threaded fasteners through the second fastener apertures 58 in threaded connection with the mounting sockets at the opposing sides of the lighting module 14. The lighting module 14 is sized to fit snugly between the distal ends of the arms 56 so that tightening the mounting screws extending through the second fastener apertures 58 and into the mounting sockets at opposing ends of the lighting module frictionally fixes the orientation of the lighting module at a selected angular position among an adjustable range of angular positions in which the lighting module is rotated about the common axis when the mounting screws are loosened.

The apparatus 10 further includes an auxiliary mount 60 on each of the arms 56 of the mounting body 50 at an intermediate location between the second fastener apertures 58 and the bridge portion onto which one or more of the auxiliary accessories described herein can be fixedly mounted in a removable and interchangeable manner while also accommodating adjustment of the angular orientation of the auxiliary accessory through a range of angles about an auxiliary axis of the auxiliary mount 60 that is parallel to the common axis of the second fastener apertures 58. In preferred embodiments, the auxiliary mount is a combination of a threaded bore 62 defining the auxiliary axis of the auxiliary mount about which auxiliary accessories can be angularly adjusted in orientation relative to the mounting body, and an interlocking connector 64 radially offset from the threaded bore to form a second connection between the mounting body and the auxiliary connector to resist rotation between the auxiliary accessory and the mounting body at a selected angular orientation.

Each of the auxiliary accessories described in the following generally includes a main bracket body 66 having a flange portion locating a fastener bore 68 therein for alignment with the threaded bore 62 of the auxiliary mount and a corresponding interlocking connector 70 that mates with the interlocking connector of the auxiliary mount. More particularly, the fastener bore 68 receives a threaded fastener inserted therethrough for threaded connection with the threaded bore 62 to fasten the bracket body 66 against the corresponding arm 56 of the mounting body 50. In the illustrated embodiments, the interlocking connector 64 of the auxiliary mount comprises a protrusion which protrudes from the outer surface of the mounting body in an axial direction of the threaded bore 62. The interlocking connector 70 on the auxiliary accessory in turn comprises one or more sockets which are radially offset from the fastener bore 68 and circumferentially spaced about an axis of the fastener bore such that each socket 70 is arranged to receive the protrusion 64 therein at a corresponding selected angular orientation of the auxiliary accessory relative to the mounting body 50 to fix the auxiliary accessory at the selected angular orientation relative to the mounting body.

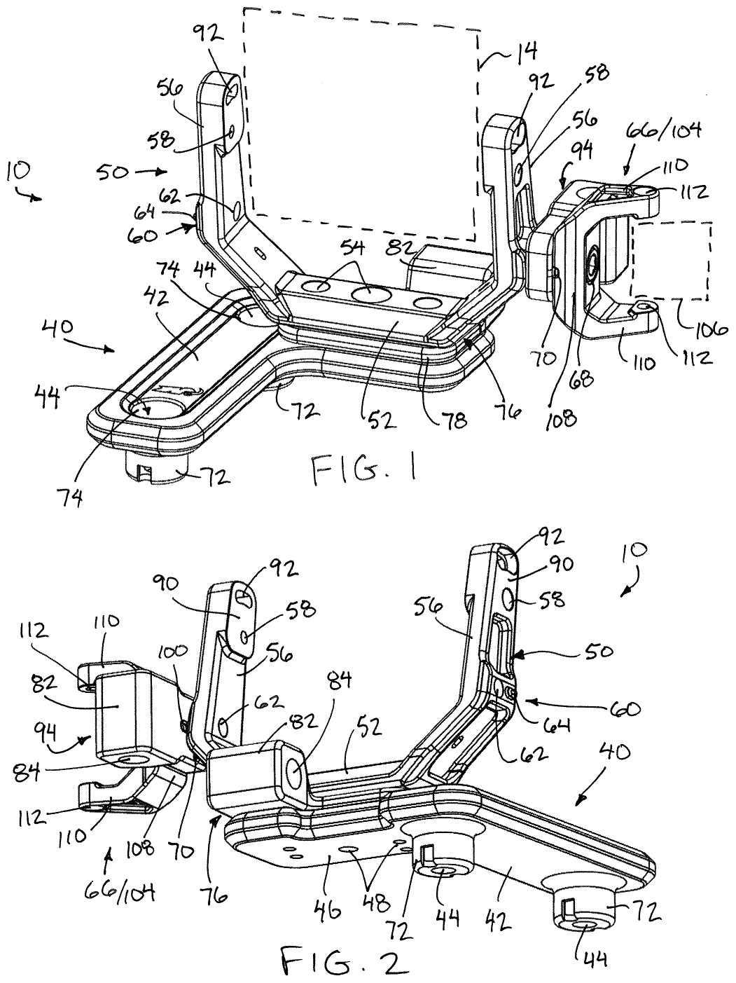

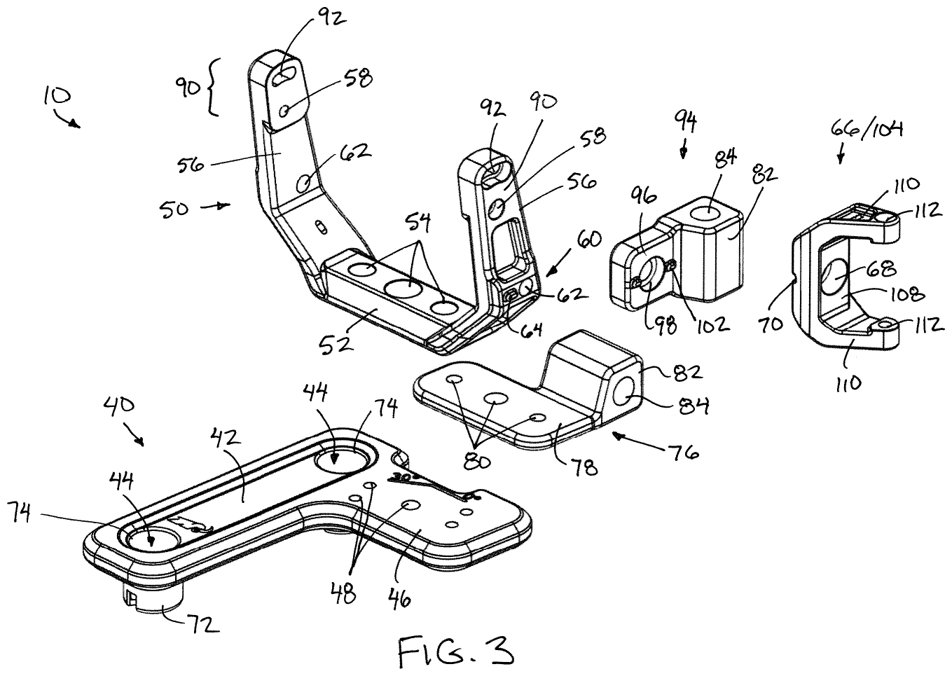

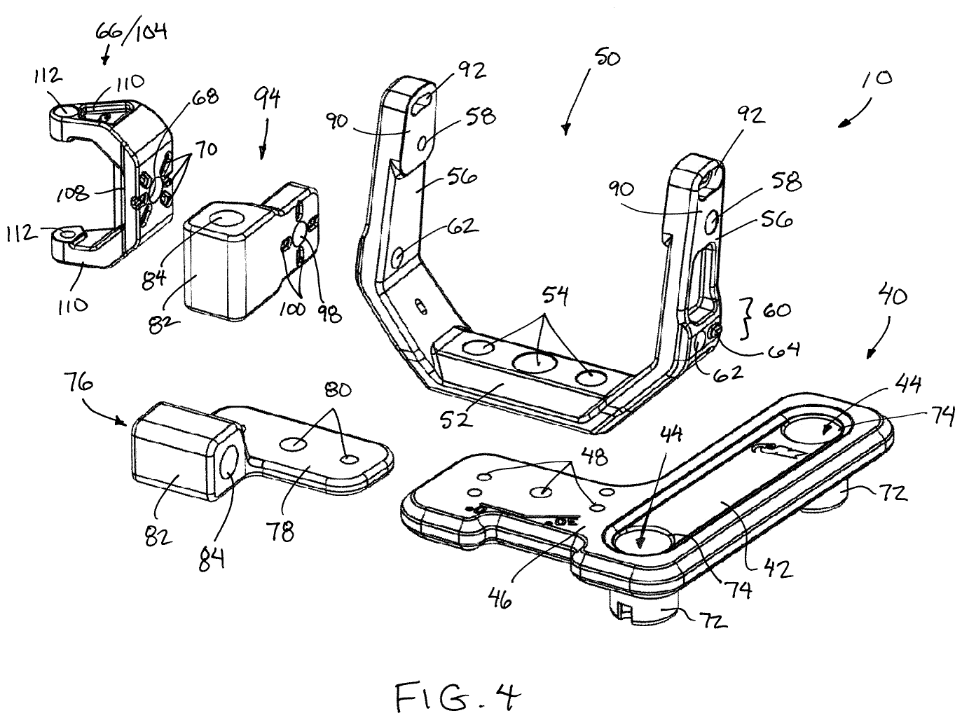

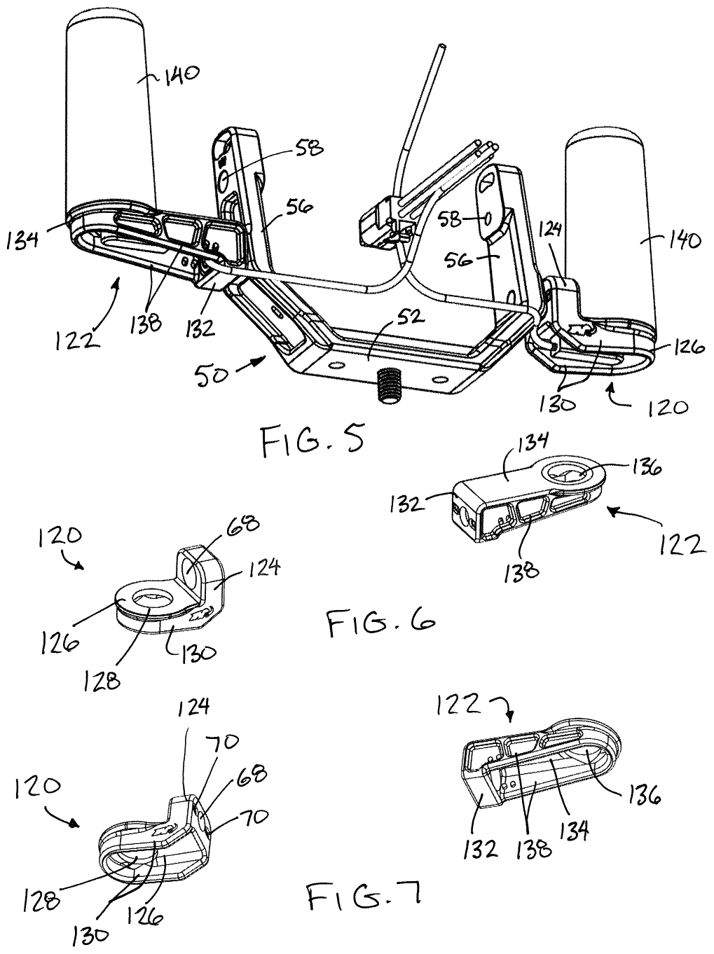

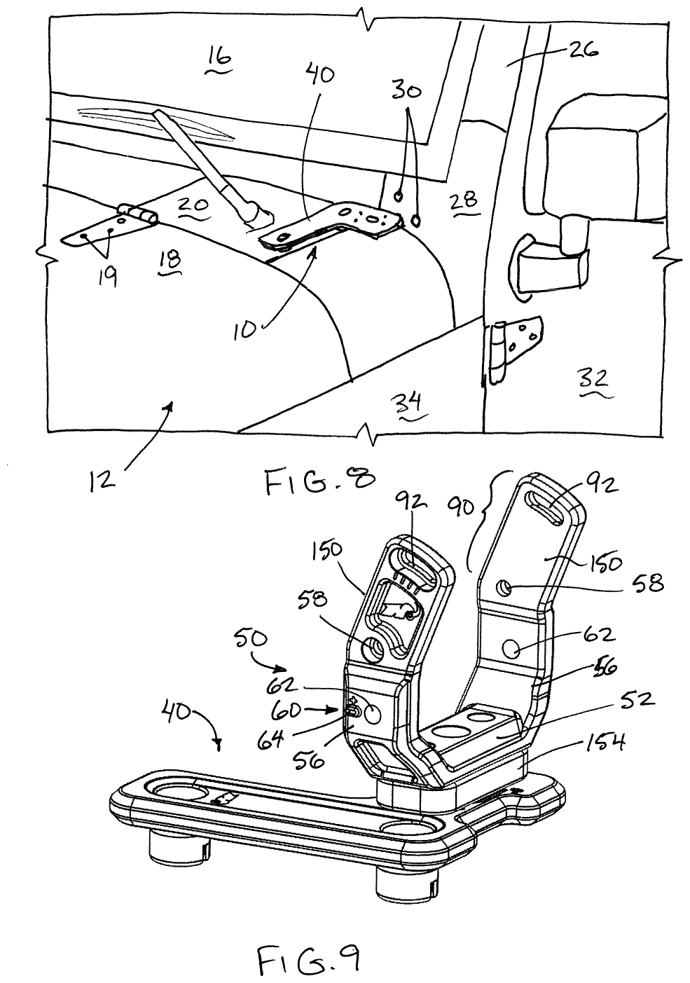

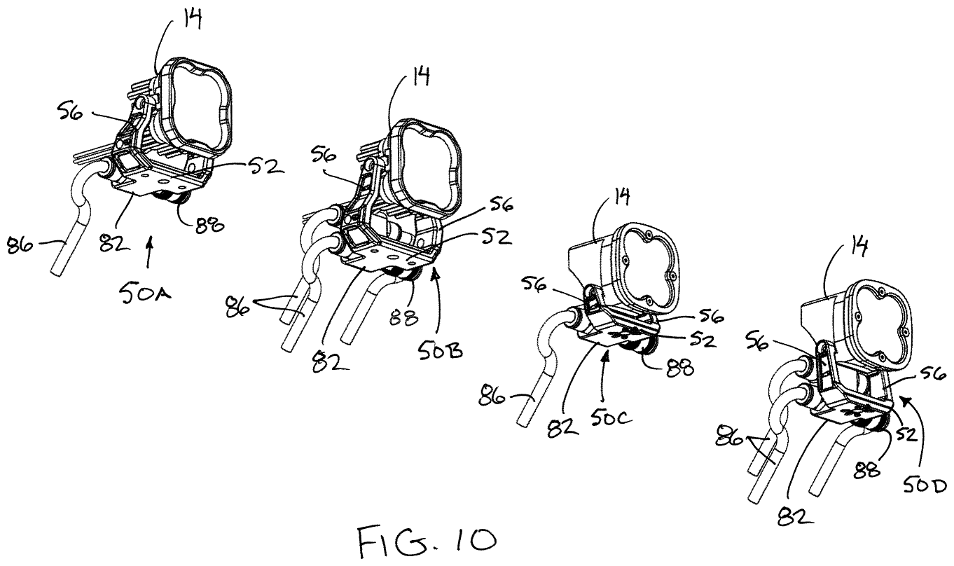

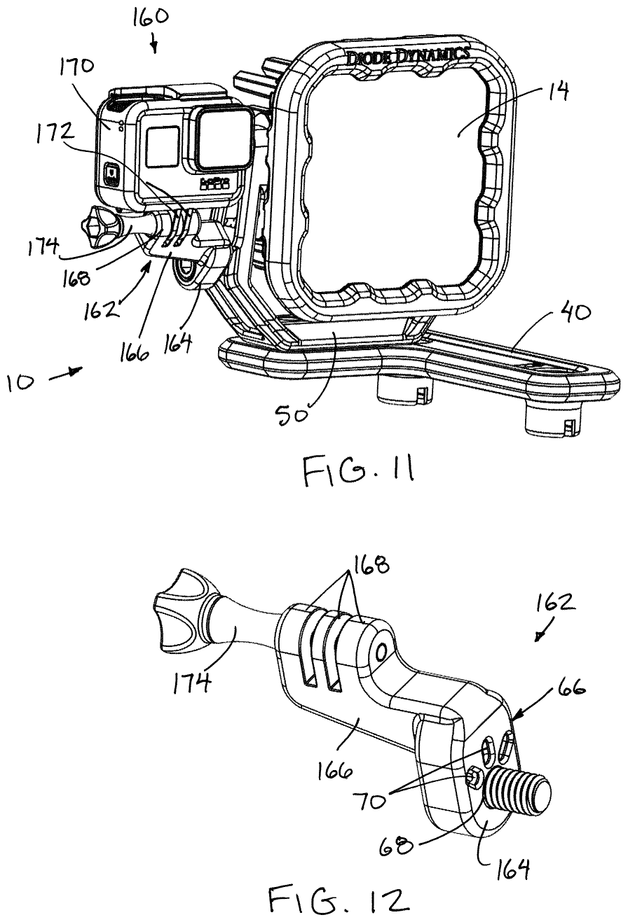

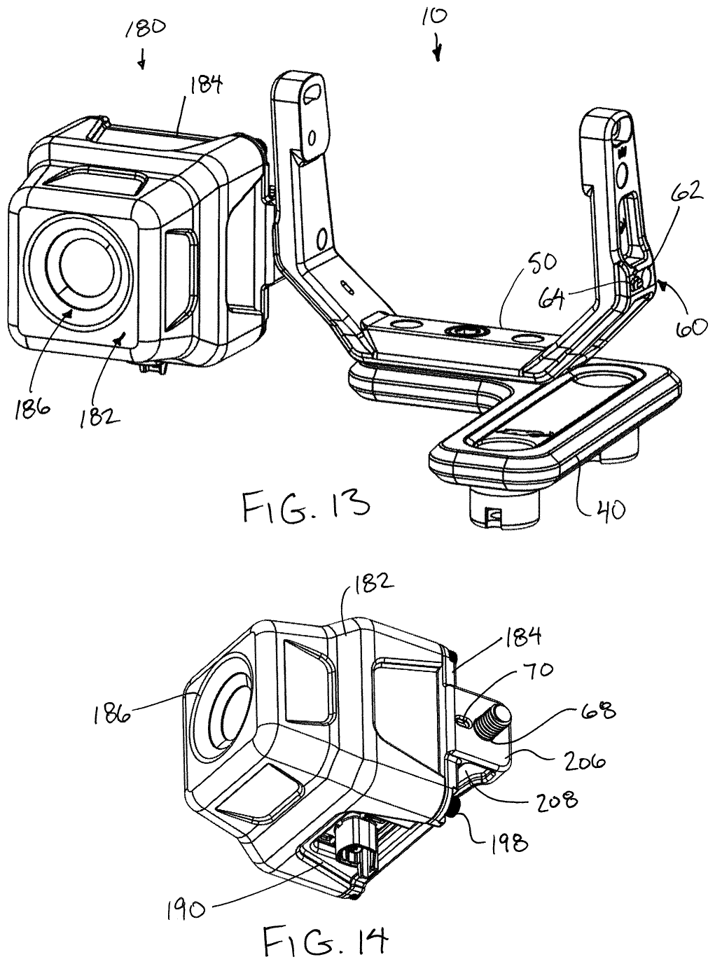

Turning now more particularly to a first embodiment of the apparatus 10 as shown in FIGS. 1 to 4 and 8, the base body 40 in this instance is generally in the form of a flat plate in which the first body portion 42 is elongated along a first axis and the second body portion 46 is elongated along a second axis which is near perpendicular to the first axis such that the first and second body portions form a flat plate which is generally L-shaped while the first and second body portions lie in a generally common plane of the flat plate. The first body portion 42 includes two legs 72 protruding from a bottom side of the first body portion at axially spaced positions towards opposing ends of the first body portion. Recessed sockets 74 are formed in the top side of the first body portion 42 in alignment with each of the legs 72 to locate the first fastener apertures 44 therein. In this manner, the base body 40 is secured to the exterior of the vehicle by receiving existing cowl fasteners 22 recessed into the sockets 74 of the legs 72 such that the legs 74 act as spacers supporting the first and second body portions of the base body 40 spaced outwardly and above the corresponding exterior surfaces of the vehicle locating the cowl fasteners 22 therein.

The base body 40 according to all embodiments is available in symmetrical left and right versions. Only the left side version for mounting on the driver side of the vehicle is shown in the accompanying illustrations. In this instance the second body portion 46 is configured to protrude laterally outwardly from the rear of the first body portion in the mounted position on the vehicle as best shown in FIG. 8.

The second fastener apertures 48 in the base body 40 include a central bore which is internally threaded and defines a vertical axis perpendicular to the plate of the base body about which the mounting body 50 can be adjusted relative to the base body 40. The central second fastener aperture 48 of the base body 40 is thus arranged for alignment with a central one of the first fastener apertures 54 in the bridge portion 52 of the mounting body to receive a common fastener therethrough about which the mounting body 50 can be pivoted between different angular orientations relative to the base body. Additional second fastener apertures 48 are provided in pairs spaced radially outward at diametrically opposing sides of the central fastener aperture for alignment with corresponding additional first fastener apertures 54 in the bridge portion of the mounting body that are likewise situated at diametrically opposing sides of the central first fastener aperture 54. In the illustrated embodiment, two sets of the additional second fastener apertures 48 are provided in the second body portion of the base body 40 for alignment with the corresponding apertures in the mounting body at different first and second orientations of the mounting body relative to the base body in which the positions are angularly offset from one another about the vertical axis of the central first fastener aperture 54 of the bridge portion of the mounting body.

According to the first embodiment, the apparatus 10 further includes a first intermediate body 76 arranged to be optionally received between the mounting body 50 and the base body 40. The intermediate body includes a flange portion 78 in the form of a flat plate with a set of intermediate apertures 80 formed therein for alignment with the first fastener apertures 54 in the bridge portion 52 of the mounting body when the flange portion 78 is mounted between the bridge portion 52 of the mounting body 50 and the second body portion 46 of the base body 40. The intermediate apertures 80 are smooth bores sized to match the fastener apertures of the mounting body so that a common set of fasteners can be received through the apertures in the mounting body and the corresponding apertures in the first intermediate body 76 to commonly fasten the mounting body and the first intermediate body to the second body portion of the base body. The first intermediate body 76 is movable together with the mounting body 50 between the different first and second orientations by aligning with the different sets of additional second fastener apertures 48 in the second body portion of the base body.

The first intermediate body further includes a working portion 82 in the form of a block of material having a through passage 84 extending fully through the block of material so as to be parallel to the flange portion 78 and parallel to the row of intermediate apertures 80, which in turn locates the passage 84 parallel to the bridge portion 52 of the mounting body in the mounted position. The through passage may be internally threaded and is sized for receiving a compressed air supply line 86 mounted therein so that the compressed air line protrudes from one end of the passage 84 and a valve coupler 88 protrudes from the other end of the passage in sealed communication through the passage with the air supply line. The valve coupler 88 allows compressed air accessories to be selectively coupled in communication with the air supply line to receive a flow of compressed air when selectively coupled to the valve coupler 88.

In the first illustrated embodiment, the arms 56 of the mounting body 50 initially extend upwardly from opposing ends of the bridge portion 52 at an outward slope diverging away from one another along a lower portion of the arms, followed by respective upper portions of the arms which continue to extend away from the bridge portion, but in parallel relation to one another. The second fastener apertures 58 are located adjacent to the distal ends of the arms 56. A remaining end portion 90 of each arm protruding beyond the second apertures 58 to the distal ends each locate a guide slot 92 therein which follows an arcuate path centred at the common axis of the second fastener apertures 58. The guide slots extend fully through the arms in the direction of the common axis while being elongated in a circumferential direction about the common axis. In this manner, a portion of the side surface of the primary lighting module 14 is visible through each of the guide slots such that a visual marker on the side of the lighting module 14 is displaced along the length of the guide slot 92 as the lighting module is angularly adjusted about the common axis of the second fastener apertures 58 to provide a visual indication of a selected angle of orientation of the lighting module relative to the mounting body. In some embodiments, circumferentially spaced apart indicia may be provided alongside the guide slot 92 to provide a further indication of the angular orientation of the lighting module 14 relative to the mounting body 50.

According to the first illustrated embodiment, the apparatus 10 in this instance also includes a second intermediate body 94 arranged to be optionally received between the mounting body 50 and the auxiliary accessory. The second intermediate body is configured somewhat similarly to the first intermediate body in that there is provided (i) a flange portion 96 having an intermediate aperture 98 therein which is sized and placed for alignment with the threaded bore 62 of the auxiliary mount 60, and (ii) a working portion with a through passage which is substantially identical to the working portion 82 and through passage 84 of the first intermediate body 76 to similarly receive an air supply line 86 and a valve coupler 88.

The flange portion 96 of the second intermediate body 94 is also provided with a first interlocking connector 100 on an inner side of the flange portion for abutment against the corresponding side surface of the mounting body 50 in which the interlocking connector is identical to the sockets forming the interlocking connectors on the auxiliary accessories. The first interlocking connectors 100 are radially offset similarly to the offset of the protruding interlocking connector 64 relative to the threaded bore 62 of the auxiliary mount 60 on the mounting body. A set of four first interlocking connectors 100 are evenly spaced circumferentially about the intermediate aperture 98 such that each socket forming a first interlocking connector 100 defines a respective angular position of the second intermediate body 94 relative to the mounting body 50. The four angular positions are offset 90 degrees from one another about the horizontal auxiliary axis of the threaded bore 62 of the auxiliary mount.

The opposing outer side surface of the flange portion 96 includes a second interlocking connector 102 formed thereon that is substantially identical to the protrusion forming the protruding interlocking connector 64 of the auxiliary mount. More particularly, the second interlocking connector 102 is provided as a diametrically opposed pair of protrusions offset on opposing sides of the intermediate aperture 98 for cooperating with corresponding socket type interlocking connectors of an auxiliary accessory mounted on the outer side of the flange portion of the second intermediate body 94 in the assembled configuration using a common fastener extending through the fastener bore 68 of the auxiliary accessory and through the intermediate aperture 98 of the second intermediate body for threading into the threaded bore 62 of the auxiliary mount. When using the second intermediate body 94, instead of the socket interlocking connectors 70 of the auxiliary accessory directly mating with the protruding interlocking connector 64 of the auxiliary mount, the socket interlocking connector 70 of the auxiliary accessory instead mate with the protruding second interlocking connector 102 on the outer side of the intermediate body while the socket type first interlocking connector 100 on the inner side of the intermediate body mates with the protruding interlocking connector 64 of the auxiliary mount.

In the first illustrated embodiment, the auxiliary accessory is a lighting mount body 104 that serves to mount a secondary lighting module 106 therein. The secondary lighting module is similar to the primary lighting module 14 and that there is provided diametrically opposed mounting sockets in opposing sides of the housing of the lighting module which are aligned with one another about a common axis of the lighting module and which are internally threaded to receive mounting screws therein respectively; however, the secondary lighting module is reduced in scale relative to the first lighting module. The lighting mount body 104 in this instance comprises a bridge portion 108 that locates the primary fastener bore 68 therein and which further locates the socket type interlocking connectors 70 on an inner side surface that mates with the second intermediate body 94 or the auxiliary mount 60 on the mounting body 50 directly. The socket type interlocking connectors 70 are provided as multiple sets of diametrically opposed pairs of sockets in which each pair of sockets aligns with the protruding second interlocking connectors 102 of the intermediate body 94 or the protruding interlocking connector 64 of the auxiliary mount to form a mating connection in a respective angular position of the lighting mount body 104 relative to the mounting body 50. The different angular positions are rotated about an axis of the threaded bore 62 relative to one another.

One of the sets of sockets corresponds to a neutral position of the lighting mount body 104 in which the bridge portion 108 is upright in orientation so that two arms 110 of the lighting mount body 104 extend laterally outwardly from opposing top and bottom ends of the bridge portion 108. The arms 110 extend from the bridge portion 108 in a generally U-shaped configuration. The arms extend non-perpendicularly from a plane of the bridge portion such that the arms are sloped rearward relative to the lateral axis of the fastener bore 68 in the bridge portion 108. This serves to offset the secondary lighting module rearwardly relative to the mounting body 50 for clearance of wiring and the like protruding from the rear of the secondary lighting module. Mounting apertures 112 are situated at the distal ends of the arms respectively for alignment along a common axis that is parallel to the bridge portion 108 for alignment with the mounting sockets at the opposing sides of the lighting module respectively. In the neutral position as illustrated, the apertures 112 in the arms are aligned along a common upright axis about which the secondary lighting module can be pivotally adjusted when the mounting screws are loosened. Tightening the mounting screws inserted through the apertures 112 of the arms 110 respectively and threaded into opposing sides of the housing of the secondary lighting module 106 serves to frictionally clamp the arms 110 against opposing sides of the housing of the secondary lighting module to frictionally retain the secondary lighting module at a selected angular orientation relative to the lighting mount body 104 and the mounting body 50 of the apparatus 10.

Turning now to FIGS. 5 through 7, according to a further embodiment of the apparatus 10, the auxiliary accessory may instead comprise a first antenna mount 120 and/or a second antenna mount 122. Each of the antenna mounts is arranged to be interchangeably mounted on the auxiliary mount 60 on either one of the arms 56 of the mounting body 50 and serves to support the base of a communications antenna 140 thereon to support the antenna relative to the mounting body 50 and the base body 40.

The first antenna mount 120 includes a first mounting flange 124 at one end of the body of the antenna mount which locates the fastener bore 68 therein that serves to mount the body onto the auxiliary mount 60 of the mounting body. The first flange 124 also includes socket type interlocking connectors 70 on the end surface of the body corresponding to the inner side of the first flange 124 that abuts against the corresponding side surface of the mounting body 50 or against the second intermediate body 94 when used. Two of the sockets are provided at diametrically opposed locations relative to the bore 68 for alignment with the protruding interlocking connector 64 of the mounting body or the pair of protruding interlocking connectors 102 of the second intermediate body. When a common fastener extends through the bore 68 to fasten the first flange 124 to the auxiliary mount 60, the interlocking connector 70 serves to lock the angular orientation of the first antenna mount 120 about the axis of the bore relative to the mounting body as in previous embodiments.

The first antenna mount 120 also includes a second flange 126 extending perpendicularly outwardly from a bottom of the first flange 124. The second flange 126 includes a mounting bore 128 extending vertically through the second flange 126 into which the base of a communications antenna can be secured for mounting the antenna on the exterior of the vehicle. Stiffener flanges 130 extend longitudinally along a bottom side of the second flange 126 and are interconnected with the first flange 124 to provide structural support between the second flange 126 and the first flange 124.

The second antenna mount 122 similarly includes a first mounting flange 132 at one end of the body of the antenna mount which locates the fastener bore 68 therein that serves to mount the body onto the auxiliary mount 60 of the mounting body. The first mounting flange 132 also includes socket type interlocking connectors 70 on the end surface of the body corresponding to the inner side of the first mounting flange that abuts against the corresponding side surface of the mounting body 50 or against the second intermediate body. Two sockets are provided at diametrically opposed locations relative to the bore 68 for alignment with the protruding interlocking connectors of the mounting body or the second intermediate body for mounting of the second antenna mount 122 similarly to the first antenna mount 120.

The second antenna mount 122 also includes a second flange 134 protruding perpendicularly outward from a top of the first mounting flange 132. The second flange 134 includes a mounting bore 136 extending perpendicularly through the second flange into which the base of a communications antenna can be secured for mounting the antenna on the exterior of the vehicle similarly to the first antenna mount. Stiffener flanges 138 are also provided to extend longitudinally along a bottom side of the second flange at opposing sides of the mounting bore 136 while being interconnected with the first mounting flange 132 to provide the function of a gusset between the first and second flanges of the second antenna mount 122. The second antenna mount 122 protrudes longitudinally outward from the first flange 132 to the mounting bore 136 at the distal end of the second flange 134 by an overall distance which is greater than the corresponding distance between the first flange 124 and the mounting bore 128 at the distal end of the second flange 126 according to the first antenna mount 120. This allows the base of the communications antenna 140 to be mounted at an adjustable spacing laterally award from the mounting body 50 by selecting which of the first or second antenna mounts 120 or 122 is used to mount the antenna 140 relative to the mounting body 50.

Turning now to FIG. 9, in this instance, an alternative embodiment of the mounting body 50 is shown supported on the same base body 40 described above. The mounting body 50 in this instance again comprises a bridge portion 52 and two arms 56. The lower portion of the arms diverging upwardly and outwardly away from one another from opposing ends of the bridge portion is similar to the previous embodiments; however, the upper portion 150 of each arm 56 in this instance is angularly offset from a vertical plane locating the bridge portion and the lower portions of the arms 56 therein. More particularly, the lower portions of the arms 56 terminate at intermediate portions 152 that are perpendicular to the bridge portion and parallel to one another for locating the auxiliary mounts 50 thereon; however, the upper portions 150 of the arms is sloped upwardly and rearwardly relative to the plane occupied by the bridge portion and the intermediate portions 152 of the arms. The second fastener apertures 58 are located at the inner ends of the upper portions 150 of the arms. The guide slots 92 in the end portions of the arms 56 remain curved about the fastener apertures 58 for alignment with a corresponding portion of the primary lighting module 14 that is visible through the slot to provide an indication of the angular orientation of the lighting module relative to the mounting body 50. Indicia spaced along the guide slot serves to indicate the angular position of the lighting module when a corresponding indicator on the housing of the lighting module lines up with a corresponding one of the indicia.

Also shown in FIG. 9, the apparatus 10 may include a spacer block 154 in the form of a flat body arranged to be received between the bridge portion 52 of the mounting body 50 and the second body portion 46 of the base body receiving the mounting body mounted thereon. The spacer block includes corresponding apertures extending through the block which align with the first fastener apertures 54 in the bridge portion 52 so that a common set of fasteners can extend through the bridge portion and through the corresponding apertures in the spacer block 154 to fasten the mounting body 50 and the spacer block 154 together relative to the base body 40. The spacer block serves primarily to raise the elevation of the mounting body 50 relative to the base body 40 and the body of the vehicle upon which the base body is mounted to provide clearance for additional accessories mounted on the apparatus 10 together with the primary lighting module 14.

As shown in FIG. 10, the mounting body 50 may vary in configuration to mount different types of lighting modules 14 relative to the base body 40. The first mounting body 50A includes arms 56 having lower portions that diverge upwardly and outwardly to intermediate portions mounting the auxiliary mounts 60 thereon, but thereafter the remaining upper portion of each arm is tapered upwardly and inwardly toward the opposing arm to provide a narrower mounting distance between the fastener apertures 58 at the distal ends of the arms 56 to mount a lighting module between the distal ends of the arms that is narrower in width between laterally opposing sides than the previous embodiments. Mounting screws extend through the fastener apertures in the arms 56 for being threaded into respective mounting sockets on opposing sides of the lighting module similarly to previous embodiments. The first mounting body 50A is also distinguished by the addition of a working portion 82A that locates a through passage therein for connection to a compressed air supply line 86 and a compressed air coupler 88 similarly to the configuration of the first intermediate body 76 but with the working portion 82A instead being formed integrally as a unitary body together with the bridge portion of the first mounting body 50A.

The second mounting body 50B is substantially identical to the mounting body 50A, but with the upper portions of the arms 56 being extended to a greater height to provide greater clearance between the lighting module 14 and the bridge body. In this instance the working portion 82B is increased in size relative to the previous embodiment so as to provide clearance for a pair of through passages extending through the working portion one above the other in the lateral direction parallel to the bridge portion so that each passage cooperates with a respective compressed air line 86 and a compressed air coupler 88.

The third mounting body 50C is configured similarly to the secondary light mounting body 104 in that the bridge portion 52 includes a single first fastener aperture 54 centrally located therein for alignment with the central fastener aperture on the second body portion 46 of the base body 40. The reduced size of the third mounting body 50 C permits it to be fixed in place relative to the base body using a single fastener. The bridge portion 52 in this instance is also provided with socket type interlocking connectors as three sets of diametrically opposed pairs of sockets that are angularly offset from one another about the axis of the bore on the bottom surface abutted against the mounting body and use. This allows the mounting body 50 C to be mounted either against the second body portion 46 of the base body 40 or on one of the arms 56 of a mounting body 50 according to the first embodiment using the features of the auxiliary mounts 60. When mounted to the auxiliary mounts 60 of the mounting body, the socket type interlocking connectors on the bridge portion of the mounting body 50C allow angular adjustment of the mounting body 50 C about the axis of the bore 62 of the auxiliary mounts 60 similarly to other auxiliary accessories described above. The mounting body 50 C in this instance also includes a working portion 82C locating a single through passage for mounting a single compressed air line 86 and valve coupler 88 thereon according to previous embodiments.

The fourth mounting body 50D is similar to the mounting body 50C, with the exception of the arms 56 being longer to provide more clearance between the lighting module and the bridge portion so that the working portion 82D has room for two passages extending laterally therethrough one above the other, each for receiving their own respective compressed air supply line 86 and valve coupler 88 in communication therewith.

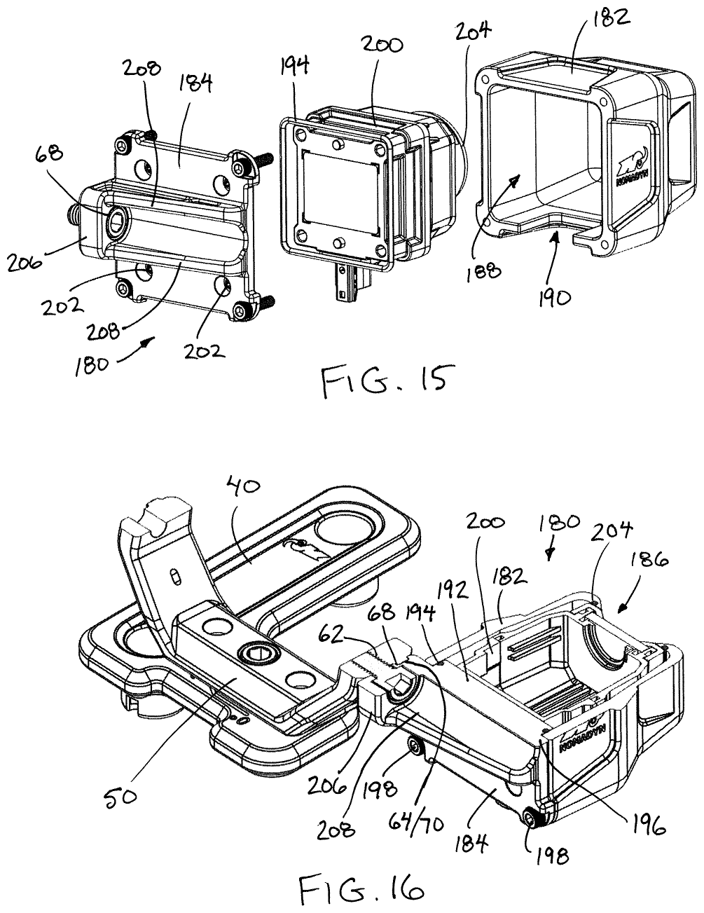

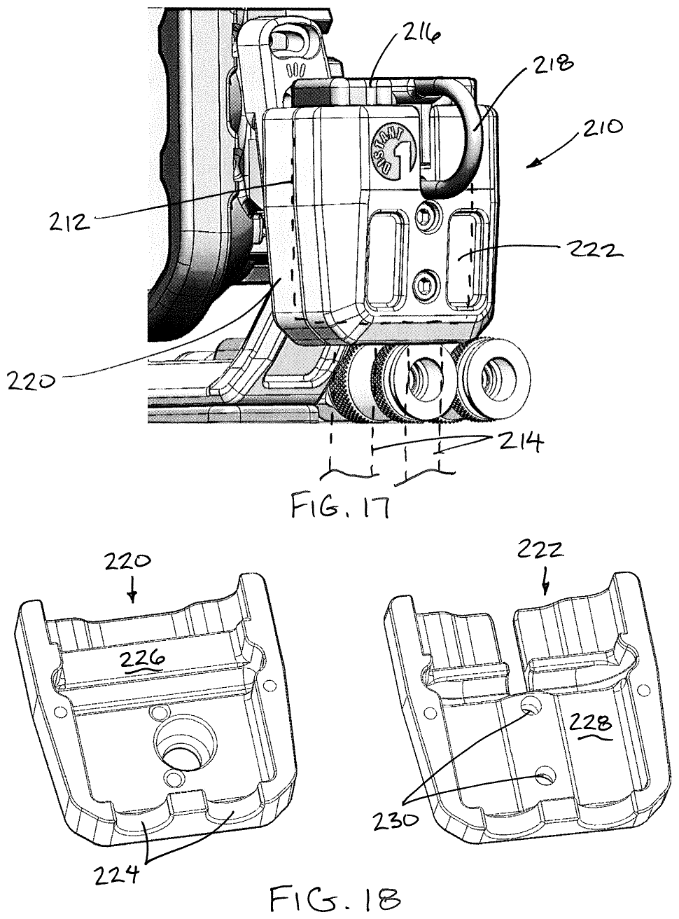

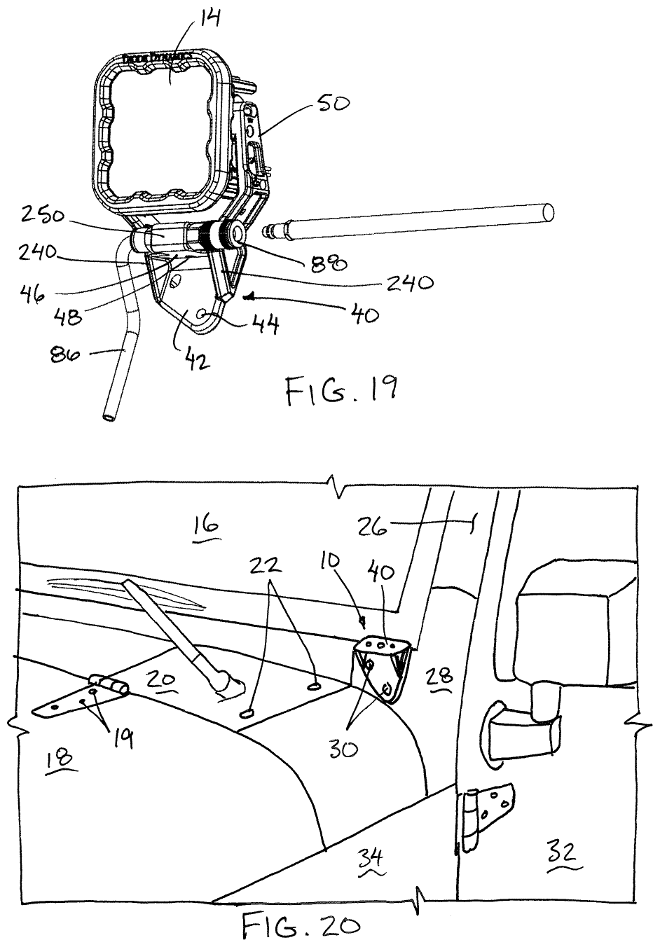

Turning now to FIGS. 11 and 12, according to a further embodiment of the apparatus 10, the auxiliary accessory mounted onto the auxiliary mounts 60 of the mounting body 50 comprises a first camera mount 160. The camera mount 160 includes a supporting body 162 having a mounting flange 164 at the inner end of the supporting body which locates the fastener bore 68 and socket type interlocking connectors 70 thereon similarly to previous embodiments for cooperating with the auxiliary mounts 60.

In this instance, three sockets are provided at circumferentially spaced positions offset to one side of the fastener bore so that a common fastener received through the fastener bore 68 can mount into the threaded bore 62 of the auxiliary mount on the mounting body while one of the sockets of the interlocking connector 70 is selected for alignment with the protruding interlocking connector 64 on the mounting body 50. Each socket of the interlocking connector 70 on the inner end of the supporting body 62 corresponds to a different angular position of the supporting body 62 rotated about the axis of the mounting bore relative to the mounting body. The supporting body 162 also includes an arm 166 extending perpendicularly outward from the mounting flange 164 at a location offset from the fastener bore 68 in the same direction that the sockets of the interlocking connector 70 are offset. The arm 166 supports a first row of knuckles 168 of a hinge thereon.

The first camera mount 160 further includes a camera housing 170 providing a case for selectively receiving a camera therein. The camera housing has a removable lid on one side to provide access to the hollow interior of the housing for inserting and removing the camera into the housing. The camera housing supports a second row of knuckles 172 thereon which are held interspersed with the first knuckles 168 of the supporting body 162 by inserting a longitudinal screw 174 through the cooperating knuckles 168 and 172. The longitudinal screw 174 is threaded into the supporting body 162 at one end of the screw and provides a gripping handle on the opposing end of the screw which protrudes from the supporting body. Tightening the screw serves to clamp the first and second knuckles together to frictionally retain the hinge at a selected angle of the camera housing relative to the supporting body 162 within a range of permissible angles about an axis of the screw. The axis of the screw is oriented parallel to the axis of the bore 68 and parallel to the bridge of the mounting body 50 so as to be generally horizontal in a mounted position on the vehicle.

According to a further embodiment shown in FIGS. 13 through 16, the auxiliary accessory of the apparatus 10 in this instance comprises a second camera mount 180. The second camera mount includes a camera housing having a front case 182 and a rear case 184 which can be selectively coupled to one another to form a camera housing with a hollow interior receiving a camera therein. The front case 182 includes a front wall with the lens opening 186 formed therein. A top wall, a bottom wall, and two side walls of the front case 182 extend rearward about a perimeter of the front wall to extend rearward to a rearward perimeter edge surrounding a rear opening 188 of the front case. A bottom opening 190 is provided in the bottom wall in open connection with the rear opening 188 to receive a wiring harness for connection to the camera therethrough in use.

The rear case 184 selectively encloses the rear opening 188 of the front case. The rear case 184 includes a first body portion 192 which is generally flat and rectangular to be received snugly within the rear opening. A rear gasket 194 is received within an annular groove extending about a perimeter of the first body portion 192 to form a sealed connection between the perimeter of the first body portion 192 of the rear case and corresponding inner surfaces of the top wall, the bottom wall and the side walls of the front case 182. The rear case 184 further includes a second body portion 196 in the form of a perimeter flange that protrudes outwardly beyond the perimeter edge of the first body portion 192 at the rear side of the rear case so that the second body portion overlaps the rear edge about the full perimeter of the front case 182 when the first body portion is inserted into the rear opening in the front case 182. A set of corner screws 198 selectively fastens the rear case onto the front case at the four corners of the camera housing respectively.

In order to mount the camera body 200 securely relative to the camera housing, an additional set of four mounting screws 202 is provided for fastening through corresponding apertures in the rear case to fasten into corresponding fastener sockets in the rear of the camera body 200. The camera housing is also sized relative to the camera body such that a front wall gasket 204 provided about a perimeter of the lens opening 186 at the front wall of the front case 182 is slightly compressed between a perimeter edge of the lens of the camera body 200 and the front wall when the camera body is first mounted to the rear case 184 by the screws 202 and the rear case is subsequently fastened into the front case 182 by corner screws 198.

The camera housing further includes a mounting flange 206 protruding from the rear side of the rear case in an upright orientation adjacent an inner side of the camera housing so as to be suitable for mounting onto the auxiliary mount 60 of the mounting body 50. More particularly, the mounting flange 206 locates the fastener bore 68 and a socket type interlocking connector 70 thereon for mating with the threaded bore 62 and the protruding interlocking connector 64 of the auxiliary mount 60 similarly to previous embodiments of the auxiliary accessory. Gusset flanges 208 are also provided on the rear of the rear case 184 in connection between the mounting flange 206 and the rear side of the rear case at diametrically opposed locations relative to the fastener bore 68 to structurally reinforce the mounting flange 206 relative to the camera housing.

Turning now to FIGS. 17 and 18, according to a further embodiment of the apparatus 10, the auxiliary accessory in this instance comprises a power socket mount 210. The power socket mount comprises a housing arranged to receive the body of an electrical power adapter 212 therein in which the power adapter has a first end locating power sockets therein and an opposing second end from which two leads 214 extend for connection to a power source of the vehicle. A removable lid 216 of the power adapter selectively encloses the sockets at the top end of the body of the adapter with the lid being connected to the body of the adapter by flexible tether 218. A pair of fastener apertures extend through the body of the adapter at spaced apart locations for mounting the adapter to various structures.

The power socket mount 210 includes a rear case 220 and a front case 222 which are selectively joined together to form a casing with a hollow interior that receives the power adapter 212 therein. In the assembled configuration, the power socket mount as a hollow interior with an open top through which the top end of the power adapter 212 is accessible for attaching and removing the lid and for accessing the power sockets within the adapter body when they lead 216 is removed. The assembled power socket mount 210 also includes two bottom openings 224 to receive the leads 214 communicating therethrough when the adapter body 212 is mounted within the power socket mount 210.

The rear case 220 in this instance comprises the rear wall 226 of the assembled mount together with a perimeter flange extending partway towards the opposing front case, while the front case 222 includes the front wall 228 of the assembled mount together with a corresponding perimeter flange extending partway towards the opposing rear case. When assembled, the perimeter flanges join one another to form a perimeter wall of the housing while supporting the front and rear wall spaced apart from one another by a suitable distance for receiving the adapter body 212 therebetween.

In this instance, the rear wall 226 locates the fastener bore 68 that receives a fastener for coupling to the threaded bore 62 of the auxiliary mount 60 on the mounting body. The inner side surface of the mount 210 that abuts against the mounting body includes one or more socket type interlocking connector 70 for cooperating with a protruding interlocking connector 64 of the auxiliary mount 60 similarly to previous embodiments.

Fastener apertures 230 are spaced apart in the front wall 228 for alignment with corresponding fastener bores extending through the adapter body 212 and into threaded bores within the inner surface of the rear wall 226 to selectively mount the front and rear cases together with the adapter body 212 received therebetween. A slot is also provided in the front wall in communication with the open top to provide access for the tether 218 of the lid 216.

Turning now to FIGS. 19 through 24, further embodiments of the base body 40 will now be described. In these instances, the first body portion 42 of the base body 40 again comprises a first flange locating first fastener apertures 44 therein; however, the first fastener apertures 44 in this instance are instead positioned for alignment with existing A-pillar bracket fasteners 30 as shown in FIG. 20. The second body portion 46 is a second flange locating the second fastener apertures 48 therein for cooperation with the fasteners communicating through the bridge portion 52 of the mounting body 50 as described in previous embodiments; however, the second flange defining the second body portion 46 in this instance is oriented at an acute angle relative to the first flange defining the first body portion 42. More particularly, the second flange is arranged to be generally horizontally oriented when the first flange is mounted at an upward and rearward slope of the front windshield by mounting the base body 42 the A-pillar bracket fasteners 30 adjacent to the front windshield. The first fastener apertures 44 in the first body portion 42 are spaced vertically and horizontally from one another for alignment with the existing vehicle fasteners 30. One of the first fastener apertures is formed as an elongated slot to provide greater tolerance for alignment with the existing fasteners on the vehicle.

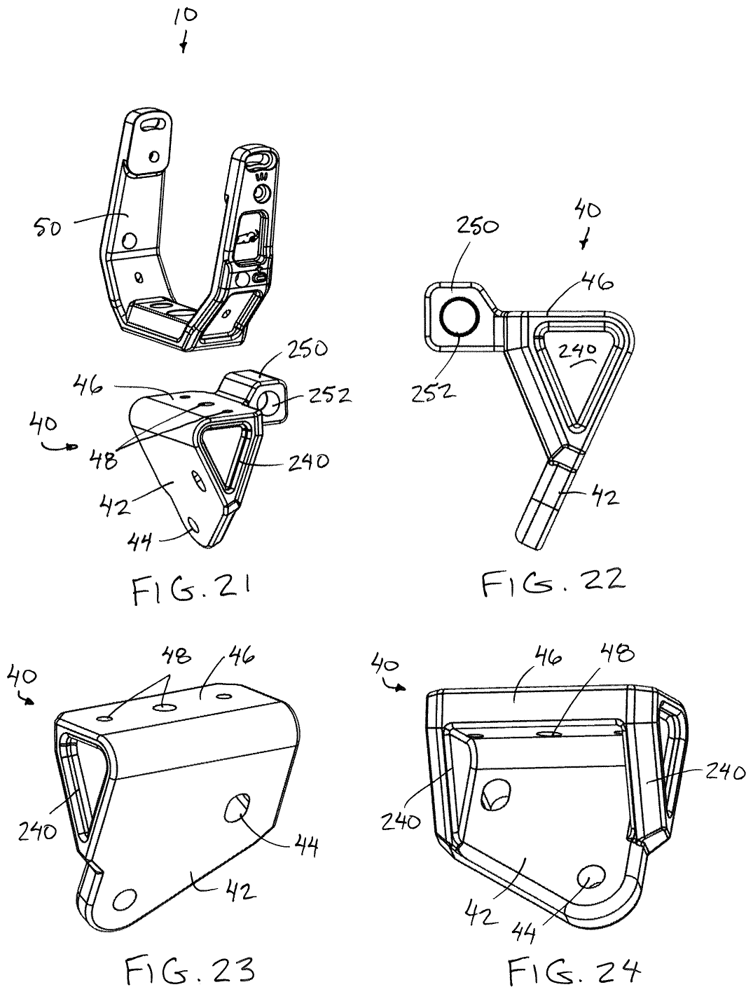

The base body 40 according to these embodiments further includes two gussets 240 which are triangular in shape for mounting at opposing sides of the body within the interior angle between the first body portion 42 and the second body portion 46. The gussets 240 provide structural support to the second body portion 46 protruding forwardly from the top edge of the first body portion 42. The second body portion 46 locates a set of three second fastener apertures 48 therein in a row corresponding to the spacing of corresponding fastener apertures in the bridge portion of the mounting body 50 described above. Similarly to the previous base body 40 the second fastener apertures are internally threaded to facilitate fastening of any embodiment of the mounting body 50 into the threaded apertures 48 on the second body portion 46. Smaller mounting bodies can be mounted using a single threaded fastener through the central aperture in the second body portion 46 while the smaller apertures at diametrically opposing sides of the central aperture are used to fix the angle of larger mounting bodies relative to the base body 40. The version of the base body 40 shown in FIGS. 19, 21 and 22 differs from the other version in FIGS. 23 and 24 by the addition of a working portion 250 protruding from the front edge of the second body portion 46 opposite to the first body portion 42. The working portion 250 includes a through passage 252 extending laterally through the working portion for connecting a compressed air supply line 86 and a valve coupler 88 optionally thereon similarly to previous embodiments.

According to various embodiments of the accessory mounting apparatus 10 described herein, any combination of a base body 40 mounted onto existing fasteners of the vehicle with a mounting body can be assembled for supporting a primary lighting module 14 together with one or more additional auxiliary accessories at a common location on the exterior of the vehicle. Furthermore, any of the auxiliary accessories can be mounted directly to any of the embodiments of the base body 40 without an intervening mounting body supporting a primary lighting module 14 thereon if desired. Similarly, the intermediate bodies can be inserted between any base body and mounting body or between any mounting body and any auxiliary accessories supported on the mounting body according to the mounting methods described above. When providing an auxiliary mount 60 on the mounting body 50, auxiliary accessories can also be adjusted through a range of angles and fixed at any selected angular orientation relative to the mounting body using a single fastener combined with the interlocking connectors providing a second connection radially offset from the fastener. In the illustrated embodiments, base bodies 40 are provided which can be secured to an externally accessible fasteners on the vehicle. In further embodiments however, the base body may be modified such that the first body portion locating the first fastener apertures 44 therein may be provided as a flange that aligns with screws supporting the hood hinge of the hood panel that encloses the forward compartment of the vehicle. The second body portion in this instance is arranged to protrude outward from the hood panel even when the hood panel is in a closed position and the hinge screws of the hood hinge are normally hidden from view beneath the closed hood panel so as to support the mounting body and the auxiliary accessories thereon as described above at a location externally on the vehicle.

In use, a user initially mounts the base body 40 onto the vehicle by removing selected existing fasteners of the vehicle and reinserting the fasteners or replacement fasteners in place of the existing fasteners in a manner that fastens the base body to the location of the existing fasteners on the vehicle. Subsequent accessories can be mounted onto the mounting body 50 which is in turn mounted onto the base body 40 at a selected orientation by inserting the fasteners into selected fastener apertures between the mounting body and the base body. In the instance of lighting modules, power for the lighting modules is wired into an appropriate power source on the vehicle. Similarly, when providing an auxiliary power socket in the form of a power adapter body, the power adapter body is likewise wired to suitable power source on the vehicle. When providing a through passage for a compressed air supply line, the compressed air supply line is connected to a suitable compressor operably mounted on the vehicle to supply compressed air. The camera can also be mounted in communication with a suitable controller accessible by the operator to control its operation while the camera remains mounted externally on the vehicle by the apparatus 10.

Since various modifications can be made in the invention as herein above described, and many apparently widely different embodiments of same made, it is intended that all matter contained in the accompanying specification shall be interpreted as illustrative only and not in a limiting sense.

1. An accessory mounting apparatus for supporting a lighting module and an auxiliary accessory on a vehicle having existing fasteners securing an exterior body portion of the vehicle, the apparatus comprising:
a base body having a pair of first fastener apertures formed therein for alignment with the existing fasteners on the vehicle so as to be arranged to mount the base body externally onto the vehicle using the existing fasteners and at least one second fastener aperture;
a mounting body having (i) a bridge locating at least one first fastener aperture so as to be arranged to fasten the bridge to said at least one second fastener aperture of the base body, and (ii) two arms extending outwardly from the bridge at spaced apart locations to form a U-shape with the bridge, wherein the two arms include second fastener apertures therein respectively along a common axis at a location spaced from the bridge, and wherein the second fastener apertures of the two arms are arranged receive fasteners of the lighting module therein such that the lighting module is angularly adjustable about said common axis; and
at least one auxiliary mount formed on the mounting body and arranged to receive the auxiliary accessory supported on the mounting body independently of the lighting module.

2. The apparatus according to claim 1 wherein said at least one second fastener aperture in the base body comprises two or more second fastener apertures, and wherein said at least one first fastener aperture in the mounting body comprises two or more first fastener apertures which are internally threaded for forming a threaded connection with fasteners extending through the second fastener apertures in the base body.

3. The apparatus according to claim 1 wherein the mounting body is securable in fixed relation to the base body in a first orientation and a second orientation which is angularly offset from the first orientation about an upright axis.

4. The apparatus according to claim 3 wherein said at least one second fastener aperture in the base body comprises a plurality of second fasteners apertures, and wherein said at least one first fastener aperture in the mounting body comprises a plurality of first fastener apertures, wherein at least two of the second fastener apertures in the base body are aligned with at least two of the first fastener apertures in the mounting body in each of the first and second orientations.

5. The apparatus according to claim 1 wherein the base body comprise a first body portion at a first end of the base body locating the first fastener apertures therein and a second body portion at an opposing second end of the base body locating said at least one second fastener aperture therein.

6. The apparatus according to claim 5 wherein the base body comprises a plate forming the first body portion and the second body portion substantially in a common plane with one another, the first body portion being elongated along a first axis and the second body portion being elongated along a second axis oriented perpendicularly to the first axis.

7. The apparatus according to claim 1 wherein the base body comprises (i) a first flange defining a first body portion locating the first fastener apertures therein and (ii) a second flange defining a second body portion locating the at least one second fastener aperture therein, the first flange and the second flange being joined to one another at an acute angle.

8. The apparatus according to claim 1 wherein said at least one auxiliary mount is formed on one of the arms between the bridge and the respective second fastener aperture of the arm.

9. The apparatus according to claim 1 wherein said at least one auxiliary mount comprises two auxiliary mounts located on the two arms respectively between the bridge and the respective second fastener apertures of the arms.

10. The apparatus according to claim 1 wherein said at least one auxiliary mount comprises (i) a threaded bore arranged to receive a fastener securing the auxiliary accessory to the mounting body such that the auxiliary accessory is angularly adjustable about an auxiliary axis of the threaded bore, and (ii) an interlocking connector arranged to form an interlocking connection with the auxiliary accessory to fix the auxiliary accessory at a selected angular orientation about the auxiliary axis.

11. The apparatus according to claim 9 in combination with the auxiliary accessory, wherein the interlocking connector comprises a protrusion formed on a first one of the mounting body and the auxiliary accessory and at least one socket formed on a second one of the mounting body and the auxiliary accessory in which the socket receives the protrusion therein at the selected angular orientation.

12. The apparatus according to claim 1 wherein said at least one socket comprises a plurality of sockets, each arranged to receive the protrusion therein at a different selected angular orientation of the auxiliary accessory relative to the mounting body about the auxiliary axis.

13. The apparatus according to claim 1 further comprising an intermediate body including (i) a flange portion arranged to be received between the mounting body and the base body and having at least one intermediate aperture therein for alignment with said at least one second fastener aperture of the base body such that the mounting body and the intermediate body are securable to the base body using a common fastener received therethrough, and (ii) a working portion arranged to support a secondary vehicle accessory thereon.

14. The apparatus according to claim 13 wherein the working portion of the intermediate body includes a through passage arranged to receive a compressed air supply line communicating therethrough.

15. The apparatus according to claim 1 in combination with the auxiliary accessory in which the auxiliary accessory is a lighting mount arranged to supporting a secondary lighting module thereon, the lighting mount including a bridge removably coupled to said at least one auxiliary mount and two arms extending outwardly from the bridge at spaced apart locations to form a U-shape with the bridge, wherein the two arms include secondary fastener apertures therein respectively along a secondary axis at a location spaced from the bridge, and wherein the secondary fastener apertures of the two arms are arranged to receive fasteners of the secondary lighting module therein such that the secondary lighting module is angularly adjustable about said secondary axis.

16. The apparatus according to claim 1 in combination with the auxiliary accessory in which the auxiliary accessory is a camera mount arranged to support a camera thereon, the camera mount being removably coupled to said at least one auxiliary mount on the mounting body.

17. The apparatus according to claim 1 in combination with the auxiliary accessory in which the auxiliary accessory is an antenna mount arranged to support an antenna thereon, the antenna mount being removably coupled to said at least one auxiliary mount on the mounting body.

18. The apparatus according to claim 1 further comprising an intermediate body including (i) a flange portion arranged to be received between said at least one auxiliary mount on the mounting body and the auxiliary accessory and having at least one intermediate aperture therein for alignment with said at least one auxiliary mount such that the auxiliary accessory and the intermediate body are securable to the mounting body using a common fastener received therethrough, and (ii) a working portion arranged to support a secondary vehicle accessory thereon.

19. The apparatus according to claim 18 wherein the working portion of the intermediate body includes a through passage arranged to receive a compressed air supply line communicating therethrough.

20. The apparatus according to claim 1 in combination with the auxiliary accessory in which the auxiliary accessory is an electrical socket mount arranged to support an electrical socket thereon, the electrical socket mount being removably coupled to said at least one auxiliary mount on the mounting body.
